(19) United States
(12) Patent Application Publication
(10) Pub. No.: US 2006/0281665 A1
(43) Pub. Date: Dec. 14, 2006

(54) Soluble builder system

(76) Inventors: Rene Artiga-Gonzalez, Dusseldorf (DE); Heike Schirmer-Ditze, Dusseldorf (DE); Kathrin Schnepp-Hentrich, Dusseldorf (DE); Heinz-Jurgen Volkel, Langenfeld (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/438,642

(22) Filed: May 22, 2006

Related U.S. Application Data
(63) Continuation of application No. PCT/EP04/10978, filed on Oct. 1, 2004.

(30) Foreign Application Priority Data
Nov. 21, 2003 (DE) DE 103 54 561.1

(51) Int. Cl. C11D 3/00

(52) U.S. Cl. 510/515

(57) ABSTRACT

The invention relates to an essentially aluminosilicate-free soluble builder system having the following constituents: alkali carbonate, co-polymeric polycarboxylate and a cationic surfactant. The invention also relates to agents of this type and to detergents and cleansers containing these agents.

### CROSS-REFERENCE TO RELATED APPLICATIONS

This application is a continuation under 35 U.S.C. §365(c) and 35 U.S.C. §120 of International Application PCT/EP2004/010978, filed Oct. 1, 2004. This application also claims priority under 35 U.S.C. §119 of German Application DE 103 54 561.1, filed Nov. 21, 2003. Each of these applications is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### (e) BACKGROUND OF THE INVENTION

(1) Field of the Invention

The invention relates to an essentially aluminosilicate-free soluble builder system that includes the constituents alkali carbonate, copolymeric polycarboxylate and cationic surfactant, as well as to the use of such compositions and to detergents and cleansers comprising these compositions.

Builders or builder systems in detergents and cleansers fulfill a plurality of functions that, because of the constant changes in the composition, the presentation forms and lastly the manufacture of detergents, are subject to mounting change. Today, modern detergents can comprise up to about 60 wt. % of builders and so these undoubtedly belong to the most important classes of materials for the design of detergents and cleansers.

As a result of the existing variety of detergent systems, the functions of the builders are multiform and not completely definable. However, the usual major functions are well described. Above all, water softening, increased washing power, a graying inhibition and dirt dispersion can be cited here. As a rule, builders are intended to contribute to the alkalinity required for the washing process, show a high absorption for surfactants, improve the activity of the surfactants, provide positive contributions to the properties of the solid products, for example, in powder form, and thereby be active as structure formers or also reduce dusting problems. These different requirements cannot normally be met with only one builder component or only very inadequately, and so generally one has to fall back on a system of builders and co-builders.

Nowadays, the three-dimensionally crosslinked, water-insoluble sodium alumosilicate zeolite NaA has become widely accepted, particularly for textile detergent formulations. Furthermore, to a large extent, particularly in the context of textile detergents, the use with a co-builder is necessary, particularly in order to counteract unwanted incrustations. Consequently, today, to a large extent together with zeolite NaA, polymeric carboxylates, particularly copolymers based on acrylic acid and maleic acid with molecular weights in the range 20,000-100,000 g/mol, are added together with soda so as to take care of the incrustation problems. These synthetic polymers of unsaturated mono or dicarboxylic acids are indeed biodegradable only with difficulty, but are removed to over 90% in water purification plants by precipitation and adsorption, and are thus inoffensive from the ecological point of view.

(2) Description of Related Art, Including Information Disclosed Under 37 CFR §§1.97 and 1.98

In spite of the importance of the zeolites there were and are many endeavors to provide reduced zeolite or even zeolite-free builder systems

German published document DE 22 40 309A describes a zeolite-free composition that comprises 5 to 40 wt. % surfactant, 30 to 70 wt. % alkali carbonate, 1 to 30 wt. % complexing agent, preferably citrate as well as 0.05 to 15 wt. % of an anti-deposition agent for calcium carbonate. This anti-deposition agent is either a phosphate, a phosphonic acid or a polymeric carboxylate.

DE 44 42 977 concerns detergents and cleansers with a reduced zeolite content. Extruded detergents and cleansers with a bulk density above 600 g/l are manufactured that comprise anionic and optionally nonionic surfactants as well as water-soluble builders such as sodium carbonate and amorphous sodium silicate in the compound and which can partially or wholly dispense with zeolite, without the occurrence of any extrusion-related processing problems during the manufacturing of the compositions. This was achieved by reducing the zeolite content to less than 19% by wt. (calculated on the basis of the anhydrous substance) and adding sodium carbonate and amorphous sodium silicate to give a total content of 10 to 40% by wt. (also calculated based on the anhydrous substances), the ratio by weight of sodium carbonate to sodium silicate lying within the range 5:1 to 1:10 and at least part of the sodium carbonate being added in granular form.

A phosphate-free and aluminosilicate-free composition is envisaged in International Patent Application WO 98/20105, which, in addition to surfactants and polyethylene glycol, comprises a builder system, based on carbonate, sulfate, silicate and polycarboxylate. The advantages of this composition reside in the price and the environmental characteristics of the builder system. Preferred embodiments have a sodium carbonate to sodium sulfate ratio of 1:1 to 1:3.

A zeolite-free builder system is known from German Patent Application DE 199 12 679 and consists of alkali silicate, alkali carbonate, polymeric polycarboxylate having a molecular weight of less than 10,000 g/mol, phosphonate and an acidic component. This soluble builder system is added in low amounts, i.e. less than 40 wt. % of the detergent is made up of this builder system and the alkali product of this composition is in the range 7.0 to 11.4. In comparison with a zeolite-based builder system, this soluble builder system exhibits advantages, particularly with regard to the behavior of the residues.

In light of this background, the subject of the present invention was to provide novel soluble builder systems that are essentially free of aluminosilicates.

### BRIEF SUMMARY OF THE INVENTION

Accordingly, the subject of this invention is essentially aluminosilicate-free, soluble builder systems that comprise the components a) alkali carbonate, b) polymeric polycarboxylate, preferably having a molecular weight less than 10 000 g/mol and/or copolymeric polycarboxylate, preferably having a molecular weight in the range of 20,000 to 70,000 g/mol, as well as c) cationic surfactant.

### BRIEF DESCRIPTION OF THE SEVERAL VIEWS OF THE DRAWING(S)

Not Applicable

### (h) DETAILED DESCRIPTION OF THE INVENTION

The alkali carbonates used in the builder system are preferably sodium and/or potassium carbonate, the use of sodium carbonate being particularly preferred. According to a preferred embodiment of the invention, the alkali carbonate is comprised in quantities of up to 90 wt. %, preferably 50 to 75 wt. %, based on the total builder system. The advantage of these quantities is seen in relation to the required alkalinity of the detergent and/or cleanser and the washing liquor into which the composition is added.

The polymeric polycarboxylates are preferably homopolymers or copolymers that comprise acrylic acid and/or maleic acid units. In the context of this invention, homopolymers are particularly preferably used, optionally in combination with copolymers, polyacrylates again being preferred. Usually, the polyacrylates are used in the form of their sodium salts. In particular, polyacrylates having a molecular weight of 3,000 to 8,000 and particularly preferably 4,000 to 5,000 g/mol have proven to be particularly well suited according to the invention. The molecular weights mentioned in this specification for polymeric polycarboxylates are weight-average molecular weights Mw that were fundamentally determined by gel permeation chromatography (GPC), equipped with a UV detector. The measurement was carried out against an external polyacrylic acid standard, which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

The copolymeric polycarboxylates are particularly those of acrylic acid with methacrylic acid and of acrylic acid or methacrylic acid with maleic acid, possessing a molecular weight between 20,000 and 70,000 g/mol. Copolymers of acrylic acid with maleic acid, which comprise 50 to 90 wt. % acrylic acid and 50 to 10 wt. % maleic acid, have proven to be particularly suitable. In order to improve the water solubility, the polymers can also comprise allylsulfonic acids as monomers, such as, for example, allyloxybenzenesulfonic acid and methallylsulfonic acid in EP-B-727448. Biodegradable polymers comprising more than two different monomer units are particularly preferred, examples being those comprising, as monomers, salts of acrylic acid and of maleic acid, and also vinyl alcohol or vinyl alcohol derivatives, as in DE-A 43 00 772, or those comprising, as monomers, salts of acrylic acid and of 2-alkylallylsulfonic acid as in DE-C42 21 381, and also sugar derivatives. Further preferred copolymers are those that are described in German Patent Applications DE-A-43 03 320 and DE-A-44 17 734 and preferably including acrolein and acrylic acid/acrylic acid salts or acrolein and vinyl acetate as monomers. In a preferred variant, these copolymers as well as the polyacrylates that are essential for the invention are used in the process, the ratio of the polyacrylate to the acrylic acid-maleic acid-copolymer being in the range 2:1 to 1:20, preferably 1:1 to 1:15.

According to a preferred embodiment of the invention, the polymeric and/or copolymeric polycarboxylates are comprised in the composition in quantities of up to 20 wt. %, preferably in quantities of 5 to 15 wt. %, based on the total builder system. The advantage of these quantities is that the use of the composition in the washing process optimally counteracts the potential precipitation of sparingly soluble alkaline earth salts onto the washing or onto the heating bars of the washing machine and promotes the color brilliance of the washing, as the polycarboxylates in these amounts have an optimal action with regard to graying inhibition.

In another, likewise preferred embodiment of the invention, the compositions comprise, besides the polymeric polycarboxylate having a molecular weight of less than 10 000 g/mol, no additional polymer of acrylic acid, particularly also no copolymer of acrylic acid with maleic acid.

The composition can comprise additional complexing agents. According to a preferred embodiment of the invention, the composition comprises at least one additional complexing agent, preferably a phosphonate and/or a citrate.

In particular, the phosphonates are hydroxyalkane phosphonates or aminoalkane phosphonates. Among the hydroxyalkane phosphonates, 1-hydroxyethane-1,1-diphosphonate (HEDP) is of particular importance. It is normally added as the sodium salt, the disodium salt reacting neutral and the tetrasodium salt reacting alkaline (pH 9). Ethylene diamine tetramethylene phosphonate (EDTMP), diethylene triamine pentamethylene phosphonate (DTPMP) and their higher homologs are preferably chosen as aminoalkane phosphonates. They are preferably added in the form of the neutral-reacting sodium salts, e.g., as the hexasodium salt of EDTMP or as the hepta and octasodium salt of DTPMP. HEDP, (1-(hydroxyethylidene)bisphosphonate), is also preferably used. The aminoalkane phosphonates additionally possess a pronounced ability to complex heavy metals. Accordingly, it can be preferred, particularly where the agents also contain bleach, to use aminoalkane phosphonates, particularly DTPMP, or mixtures of the mentioned phosphonates. These types of phosphonates are advantageously comprised in the compositions in quantities of 0.05 to 2.0 wt. %, preferably in quantities of 0.1 to 1 wt. %.

Citrates are salts of citric acid. In the context of the invention, alkali metal citrates are particularly preferred. The citrates are advantageously comprised in the compositions in quantities of 2.5 to 10 wt. %, preferably in quantities of 3.5 to 6.0 wt. %.

Instead of citrates and/or phosphonates, other complexing agents can be (or when required also additionally) used as replacements. Further suitable complexing agents as named in the English language in INCI are, for example, the following that are described in more detail in the International Cosmetic Ingredient Dictionary and Handbook: Aminotrimethylene Phosphonic Acid, Beta-Alanine Diacetic Acid, Calcium Disodium EDTA, Cyclodextrin, Cyclohexanediamine Tetraacetic Acid, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Pentetate, Pentasodium Triphosphate, Pentetic Acid, Phytic Acid, Potassium Citrate, Potassium Gluconate, Potassium Polyphosphate, Ribonic Acid, Sodium Dihydroxyethylglycinate, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium, Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Tertiary amines, particularly tertiary alkanolamines, (amino alcohols) are also usable as complexing agents. The alkanolamines possess both amino and hydroxyl and/or ether groups as functional groups. Particularly preferred tertiary alkanolamines are triethanolamine and tetra-2-hydroxypropylethylenediamine (N,N,N′,N′-tetrakis-(2-hydroxypropyl)ethylenediamine). Particularly preferred combinations of tertiary amines with zinc ricinoleate and one or a plurality of ethoxylated fatty alcohols as the nonionic solubilizer as well as optional solvents are described in DE 40 14 055 C2 (Grillo-Werke) to which reference is made in this context and the contents of which are hereby incorporated into this application.

Further possible builders are alkali silicates. The alkali silicates in the inventively preferred embodiments are those with a modulus M₂O:SiO₂ in the range 1:1.9 to 1:3.3, wherein M stands for an alkali metal ion, in particular, amorphous silicates with a modulus Na₂O:SiO₂ of 1:2 to 1:3.3, preferably from 1:2 to 1:2.8 and particularly from 1:2 to 1:2.6, which have a delayed dissolution and exhibit secondary washing properties. The delay in dissolution compared with conventional amorphous sodium silicates can have been obtained in various ways, for example, by surface treatment, compounding, compressing/compacting or by over-drying. In the context of this invention, the term “amorphous” also means “X-ray amorphous.” In other words, the silicates do not produce any of the sharp X-ray reflections typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is interpreted to mean that the products have microcrystalline regions between 10 and a few hundred nm in size, values of up to at most 50 nm and especially up to at most 20 nm being preferred. This type of X-ray amorphous silicates, which similarly possess a delayed dissolution in comparison with the customary water glasses, are described, for example, in German Patent Application DE-A-44 00 024. Compacted/densified amorphous silicates, compounded amorphous silicates and over-dried X-ray-amorphous silicates are particularly preferred. Granular, amorphous alkali silicates with bulk densities of at least 700 g/l can be manufactured, for example, according to one of the processes described in WO 97/34977 which starts off with spray drying and includes the compaction of the spray dried beads. Here, the spray dried bead is milled and simultaneously or subsequently granulated in the presence of a liquid granulation auxiliary, wherein bulk densities are adjusted to at least 700 g/l-up to above 1,000 g/l.

In a further preferred embodiment of the invention, crystalline, layered sodium silicates that correspond to the general formula Na₂SiₓO₂ₓ₊₁.yH₂O are used, wherein x is a number from 1.9 to 4 and y is a number from 0 to 20 and preferred values for x are 2, 3 or 4. These types of crystalline, layered silicates are described, for example, in European Patent Application EP-A-0 164 514. Preferred crystalline, layered silicates of the given formula are those in which M stands for sodium and x assumes the values 2 or 3. Both beta- and delta-sodium disilicates Na₂Si₂O₅ yH₂O are particularly preferred.

Independently of which alkali silicate is used, the total alkali silicate content in the compositions preferably ranges from 0.5 to 20 wt. %, particularly 3 to 10 wt. %.

The result of these preferred amounts advantageously deliver an essentially optimum contribution to the alkalinity of the detergent or the washing liquor in which the inventive composition is preferably incorporated, and therefore reinforce the total cleansing power and contribute to the inhibition of the corrosion of certain constructional elements of the washing machine.

According to a preferred embodiment of the invention, the composition comprises an acidifying component. All the suitable acid components used in detergents and cleansers are suitable for this purpose. Preferably, they may be both carboxylic acids as well as mineral acids or acid salts of mineral acids. Advantageously, among the carboxylic acids, polycarboxylic acids are preferred, such as, in particular, citric acid, adipic acid, succinic acid, glutaric acid, tartaric acid, sugar acids, amino carboxylic acids, nitrilotriacetic acid (NTA), providing its use is not ecologically unsafe, and mixtures thereof. These acids may be anhydrous or used in the form of their hydrates. Among the suitable mineral acids, one can cite, in particular, sulfuric acid, phosphoric acid, carbonic acid and hydrochloric acid, as well as their salts. Preferably, citric acid and/or sodium hydrogen sulfate are added as the acidic components in the inventive compositions, wherein the sole addition of citric acid represents a particularly advantageous embodiment. The content of the acidifying component in the composition is preferably, however, not more than 10.0 wt. % and, in particularly preferred embodiments, is in the range 0.1 to 5 wt. %. In principle, the acidic component may be added in all the manufacturing steps of the composition. However, when the acidifying component is mixed later with the detergent or cleanser, it is preferred that the acidifying component is present either alone or in the form of compounds with other, preferably neutral reacting detergent or cleanser ingredients.

Of course, the salts of the carboxylic acids can also be advantageously comprised in the composition, preferably the salts of citric acid, adipic acid, succinic acid, glutaric acid, tartaric acid, sugar acids, amino carboxylic acids and/or nitrilotriacetic acid (NTA) and/or mixtures thereof.

In a further preferred embodiment of the invention, the cationic surfactant is comprised in the composition in quantities of up to 5 wt. %, preferably in quantities of up to 4 wt. %, particularly in quantities of 1 to 3 wt. %, based on the total builder system. These amounts are therefore very advantageous, as firstly, the washing power of a detergent in which the inventive, soluble builder system is normally comprised is essentially not impaired, but secondly, the textiles in the washing process become very soft and supple, have a reduced drying time, are easier to iron and if required are even rendered antistatic. Furthermore, to some extent, there surprisingly results extremely significant advantages in regard to the formation of incrustations on substrate surfaces. A significant decrease in the tendency to incrustation and an improvement in the whiteness can be observed, particularly on at least partially hydrophobic or water-repellent substrate surfaces, preferably textiles, and is a great advantage. Besides the softness aspect, improvements in graying and secondary washing power were also totally unexpected and substantiate that cationic surfactant is active, at least inside the inventive builder system, and acts synergistically with the other components of the inventive builder system, preferably with alkali carbonate and copolymeric polycarboxylate.

In a preferred embodiment of the invention, the cationic surfactant comprised in the composition is a quaternary ammonium compound, preferably an alkylated quaternary ammonium compound.

According to a preferred embodiment, the quaternary ammonium compound is in accordance with Formula (1),
R¹(R²)(R³)(R⁴)N⁺X⁻, wherein (I)
R¹, R² and R³ independently of one another are selected from C₁-C₄ alkyl, C₁-C₄ hydroxyalkyl, benzyl and —(C₂H₄O)ₓH, with x equal to 2 through 5, and wherein R⁴ is a C₈-C₂₂ alkyl, and wherein X⁻ is an anion, preferably a halide, methosulfate, methophosphate or phosphate ion as well as mixtures thereof.

According to a further preferred embodiment of the invention, the quaternary ammonium compound is in accordance with Formula (II),
R⁵R⁶ₙR⁷₃₋ₙN⁺X⁻ (II)
wherein R⁵ is a C₆-C₂₄ alkyl or alkenyl, wherein each R⁶ independently of one another is a —(CₙH2ₙO)ₓR⁸group, with n equal to 1 though 4 and with x equal to 1 through 14, and wherein R⁸ is a methyl, ethyl or preferably a hydrogen, and wherein each R⁷ independently of each other is a C₁-C₁₂ alkyl or alkenyl group, with m equal to 1 through 3, and wherein X⁻ is an anion, preferably a halide, methosulfate, methophosphate or phosphate ion as well as mixtures thereof. In particular, R⁶ is a —CH₂CH₂OH group, in particular, each R⁷ independently of one another is a C₁-C₄ alkyl, with m equal to 1 or 2, and, in particular, R⁵ is a linear C₆-C₁₄ alkyl group.

The inventive builder systems that comprise quaternary ammonium compound according to Formula (I) and/or (II), are advantageous because for appropriate applications, they lead to the fact that textiles not only become very soft and supple, have a reduced drying time, are easier to iron and if required are even rendered antistatic, but in some cases can also effect marked improvements in regard to incrustation behavior, whiteness, graying and secondary washing power. Significant advantages result in regard to the formation of incrustations on substrate surfaces. A significant decrease in the tendency to incrustation and a marked improvement in the whiteness can be observed, particularly on at least partially hydrophobic or water-repellent substrate surfaces, principally textiles. In addition to the whiteness aspect, significant improvements are generally also obtained for graying and secondary washing power.

In an extremely preferred embodiment, the cationic surfactant is a C₈-C₁₆-alkyl di(hydroxyethyl)-methyl ammonium compound, preferably a C₁₂-C₁₄-alkyl di(hydroxyethyl)-methyl ammonium compound and/or a C₈-C₁₆-alkyl hydroxyethyl-dimethyl ammonium compound, preferably C₁₂-C₁₄-alkyl hydroxyethyl-dimethyl ammonium compound, particularly their halides, methosulfates, methophosphates or phosphates as well as their mixtures.

An important advantage of the last embodiment is that those builder systems that comprise these specific cationic surfactants demonstrate excellent washing results, particularly in relation to incrustations. The tendency for forming incrustations, particularly in the context of an automatic washing process, is drastically reduced when such builder systems are employed. The use of a detergent that contains the inventive soluble builder system very significantly reduces incrustations, particularly on substrate surfaces that have been rendered hydrophobic, especially textiles that comprise at least partially hydrophobic fibers or that have been rendered hydrophobic. Similarly, the whiteness of these textiles is especially very significantly improved. Overall, the addition of these specific soluble builder systems provides quite exceptional results, particularly in regard to graying and secondary washing power of textiles, especially for at least partially hydrophobic textiles or those that have been rendered hydrophobic. These advantages are accompanied by an optimal softness of these textiles after appropriate application of the inventive builder system.

In the context of the invention, the above-mentioned cationic compounds are indeed exceedingly significantly predestined; none the less however, other cationic surfactants can also be used with advantage: alkylated quaternary ammonium compounds, preferably with two hydrophobic groups that are, in particular, linked through ester or amido bonds with a quaternized di or triethanolamine or an analogous compound.

Such compounds are advantageously selected from those of the following Formula (III): 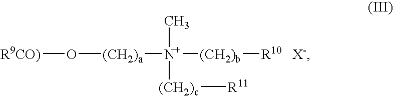
in which R⁹ stands for an aliphatic alkyl group with 12 to 22 carbon atoms with 0, 1, 2 or 3 double bonds; R¹⁰ stands for H, OH or especially O(CO)R¹², R¹¹, independently of R¹⁰, stands for H, OH or O(CO)R¹³, wherein R¹² and R¹³, independently of each other, each stands for an aliphatic alkyl group having 12 to 22 carbon atoms with 0, 1, 2 or 3 double bonds, a, b and c independently of each other can each have the value 1, 2 or 3, X⁻ is a suitable anion, preferably a halide, methosulfate, methophosphate or phosphate ion as well as mixtures thereof, and/or have Formula (IV): 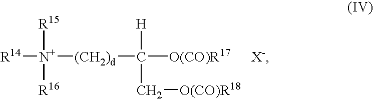
wherein R¹⁴, R¹⁵ and R¹⁶ independently of one another stand for a C₁₋₄ alkyl, alkenyl or hydroxyalkyl group, R¹⁷ and R¹⁸, each independently selected, represents a C₈₋₂₈ alkyl group with 0, 1, 2 or 3 double bonds and u is a number between 0 and 5, X⁻ is a suitable anion, preferably a halide, methosulfate, methophosphate or phosphate ion as well as mixtures thereof.

Preferred representatives of this family are N-methyl-N(2-hydroxyethyl)-N,N-(ditallowacyloxyethyl)ammonium methosulfate or N-methyl-N(2-hydroxyethyl)-N,N-(dipalmitoylethyl)ammonium methosulfate.

A further subject of the invention consists of detergents and/or cleansers that comprise an inventive agent that possesses at least one of the above-mentioned features.

According to a preferred embodiment of the invention, an inventive detergent or cleanser is characterized in that the inventive, soluble builder system is comprised in quantities of up to 50 wt. %, preferably 25 to 45 wt. %, based on the total detergent or cleanser.

The compositions do not comprise or comprise only low amounts of aluminosilicates or zeolites. If they are present, however, it is not for their water softening action or their carrier function. They may only be present when they are used as granulation auxiliaries or for dusting. In a further preferred embodiment of the invention, the detergents and/or cleansers comprise less than 10 wt. %, preferably less than 5 wt. %, advantageously less than 3 wt. %, even more advantageously less than 2 wt. %, most advantageously less than 1 wt. % aluminosilicate, based on the total detergent or cleanser, but especially they are totally free of zeolite.

The zeolites A, P, X and Y are preferably used as the aluminosilicates. However, mixtures of A, X, Y and/or P are also suitable. Zeolite MAP TM (commercial product of the Crossfield company), for example, is particularly preferred as the zeolite P. A cocrystallized sodium/potassium aluminum silicate from Zeolite A and Zeolite X, which is available as VEGOBOND AX TM (commercial product from Condea Augusta S.p.A.), is also of particular interest.

Important ingredients of the inventive detergent and/or cleanser are anionic, zwitterionic, amphoteric and/or nonionic surfactants, particularly anionic surfactants, which are preferably comprised in the inventive detergents and/or cleansers in amounts of at least 0.5 wt. %. These especially include sulfonates and sulfates, but also soaps. Cationic surfactants, as ingredients of the inventive builder system, are also comprised in the detergent and cleanser, however, not over and above that.

Suitable surfactants of the sulfonate type are advantageously C₉₋₁₃ alkylbenzene sulfonates, olefin sulfonates, i.e. mixtures of alkene- and hydroxyalkane sulfonates, and disulfonates, as are obtained, for example, by the sulfonation with gaseous sulfur trioxide of C₁₂₋₁₈ monoolefins having a terminal or internal double bond and subsequent alkaline or acidic hydrolysis of the sulfonation products.

Those alkane sulfonates, obtained from C₁₂₋₁₈ alkanes by sulfochlorination or sulfoxidation, for example, with subsequent hydrolysis or neutralization, are also suitable.

Esters of alpha-sulfofatty acids (ester sulfonates), e.g., the alpha-sulfonated methyl esters of hydrogenated coconut-, palm kernel- or tallow fatty acids, obtained by alpha-sulfonation of the methyl esters of fatty acids of vegetal and/or animal origin with 8 to 20 carbon atoms in the fatty acid molecule and subsequent neutralization to water-soluble mono salts, are also suitable. They are preferably alpha-sulfonated esters of hydrogenated coconut-, palm kernel- or tallow fatty acids, wherein sulfonation products of unsaturated fatty acids, for example, oleic acid, may also be present in small quantities, preferably in quantities of not more than about 2 to 3 wt. %. Alpha-sulfofatty acid esters that have not more than 4 carbon atoms in the ester group are especially preferred, for example, methyl esters, ethyl esters, propyl esters and butyl esters. The methyl esters of the alpha-sulfofatty acids (MES), and also their saponified di salts, are used with particular advantage.

Further suitable anionic surfactants are sulfated fatty acid glycerin esters represented by mono-, di- and triesters and also their mixtures, such as those obtained by the esterification of a monoglycerin with 1 to 3 moles fatty acid or by the transesterification of triglycerides with 0.3 to 2 moles glycerin.

Preferred alk(en)yl sulfates are the alkali and especially the sodium salts of the sulfuric acid half-esters of the C₁₂-C₁₈ fatty alcohols, for example, from coconut butter alcohol, tallow alcohol, lauryl, myristyl, cetyl or stearyl alcohol or from C₁₀-C₂₀ oxo alcohols and those half-esters of secondary alcohols of these chain lengths.

Additionally preferred are alk(en)yl sulfates of the said chain lengths, which contain a synthetic, straight-chained alkyl group produced on a petro-chemical basis, which show similar degradation behavior to the suitable compounds based on fat chemical raw materials. The C₁₂-C₁₆ alkyl sulfates and C₁₂-C₁₅ alkyl sulfates and C₁₄-C₁₅ alkyl sulfates are particularly preferred on the grounds of laundry performance. The 2,3-alkyl sulfates, which are manufactured, for example, according to the U.S. Pat. Nos. 3,234,258 or 5,075,041, and which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, such as 2-methyl-branched C₉₋₁₁ alcohols with an average of 3.5 mol ethylene oxide (EO) or C₁₂₋₁₈ fatty alcohols with 1 to 4 EO. Due to their high foaming performance, they are only used in relatively small quantities in detergents, for example, in amounts of 1 to 5% by weight.

Other suitable anionic surfactants are the salts of alkylsulfosuccinic acid, which are also referred to as sulfosuccinates or esters of sulfosuccinic acid, and the monoesters and/or di-esters of sulfosuccinic acid with alcohols, preferably fatty alcohols and especially ethoxylated fatty alcohols. Preferred sulfosuccinates comprise C₈ to C₁₈ fatty alcohol groups or mixtures of them. Especially preferred sulfosuccinates contain a fatty alcohol residue derived from the ethoxylated fatty alcohols that are under consideration as nonionic surfactants (see description below). Once again the especially preferred sulfosuccinates are those, whose fatty alcohol residues are derived from ethoxylated fatty alcohols with narrow range distribution. It is also possible to use alk(en)ylsuccinic acid with preferably 8 to 18 carbon atoms in the alk(en)y chain or its salts.

Fatty acid derivatives of amino acids, for example, N-methyltaurine (taurides) and/or N-methylglycine can be considered as further anionic surfactants. The sarcosoides or the sarcosinates and here, above all the sarcosinates of higher and optionally mono or polyunsaturated fatty acids such as oleyl sarcosinate are especially preferred.

Further suitable anionic surfactants are, in particular, soaps, preferably in amounts of 0.2 to 5 wt. %, based on the total detergent and/or cleanser. Saturated fatty acid soaps are suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid. The known alkyl succinic acid salts can also be used together with these soaps or instead of soaps.

The anionic surfactants, (and soaps) may be in the form of their sodium, potassium or ammonium salts or as soluble salts of organic bases, such as mono-, di- or triethanolamine. Preferably, anionic surfactants are in the form of their sodium or potassium salts, especially sodium.

The anionic surfactants are comprised in the inventive detergents and/or cleansers or used in the inventive process preferably in amounts of 1 to 30 wt. % and especially in amounts of 5 to 25 wt. %.

Besides the anionic surfactants and zwitterionic and amphoteric surfactants, nonionic surfactants are particularly preferred.

Preferred nonionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups.

Particularly preferred are, however, alcohol ethoxylates with linear groups from alcohols of natural origin with 12 to 18 carbon atoms, e.g., from coco-, palm-, tallow- or oleyl alcohol, and an average of 2 to 8 EO per mol alcohol. Exemplary preferred ethoxylated alcohols include C₁₂₋₁₄-alcohols with 3 EO or 4EO, C₉-C₁₁-alcohols with 7 EO, C₁₃-C₁₅-alcohols with 3 EO, 5 EO, 7 EO or 8 EO, C₁₂-C₁₈-alcohols with 3 EO, 5 EO or 7 EO and mixtures thereof, such as mixtures of C₁₂-C₁₄-alcohols with 3 EO and C₁₂-C₁₈- alcohols with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these nonionic surfactants as described above, fatty alcohols with more than 12 EO can also be used. Examples of these are tallow fatty alcohols with 14 EO, 16 EO, 20 EO, 25 EO, 30 EO or 40 EO.

The nonionic surfactants also include alkyl glycosides that satisfy the general formula RO(G)x, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number—that as an analytically determined parameter can also assume fractional values—between 1 and 10, preferably between 1.2 and 1.4.

Polyhydroxyfatty acid amides of Formula (V) are likewise suitable in which R¹⁹CO stands for an aliphatic acyl group with 6 to 22 carbon atoms, R²⁰ for hydrogen, an alkyl or hydroxyalkyl group with to 1 to 4 carbon atoms and Z for a linear or branched polyhydroxyalkyl group with 3 to 10 carbon atoms and 3 to 10 hydroxyl groups.

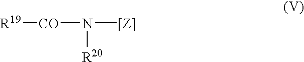

The polyhydroxyfatty acid amides are advantageously derived from reducing sugars having 5 or 6 carbon atoms, especially from the glucoses. The group of polyhydroxyfatty acid amides also includes compounds corresponding to the Formula (VI), 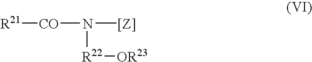
in which R²¹ stands for a linear or branched alkyl or alkenyl group comprising 7 to 12 carbon atoms, R²² for a linear, branched or cyclic alkylene group or an arylene group comprising 2 to 8 carbon atoms and R²³ for a linear, branched or cyclic alkyl group or an aryl group or an oxyalkyl group comprising 1 to 8 carbon atoms, C₁₋₄ alkyl or phenyl groups being preferred, and Z for a linear polyhydroxyalkyl group, of which the alkyl chain is substituted by at least two hydroxyl groups, or alkoxylated, preferably ethoxylated or propoxylated derivatives of that radical. Z is preferably obtained by reductive amination of a sugar such as glucose, fructose, maltose, lactose, galactose, mannose or xylose. The N-alkoxy- or N-aryloxy-substituted compounds may then be converted, for example, according to the teaching of International Application WO 95/07331, into the required polyhydroxyfatty acid amides by the reaction with fatty acid methyl esters in the presence of an alkoxide as the catalyst

Another class of preferred nonionic surfactants which are used either as the sole nonionic surfactant or in combination with other nonionic surfactants, in particular, together with alkoxylated fatty alcohols and/or alkyl glycosides, are alkoxylated, preferably ethoxylated or ethoxylated and propoxylated fatty acid alkyl esters preferably containing 1 to 4 carbon atoms in the alkyl chain, more particularly the fatty acid methyl esters which are described, for example, in the Japanese Patent application JP 58/217598 or which are preferably produced by the process described in International Patent Application WO-A-90/13533. C₁₂-C₁₈fatty acid methyl esters with an average of 3 to 15 EO, in particular, with an average of 5 to 12 EO are preferred as nonionic surfactants, whereas—as described above—principally highly ethoxylated fatty acid methyl esters are advantageous as binding agents. In particular, C₁₂-C₁₈ fatty acid methyl esters with 10 to 12 EO may be used as both surfactants and also binding agents.

Nonionic surfactants of the amine oxide type, for example, N-cocoalkyl-N,N-dimethylamine oxide and N-tallow alkyl-N,N-dihydroxyethylamine oxide, and the fatty acid alkanolamides may also be suitable. The quantity in which these nonionic surfactants are used is preferably no more than the quantity in which the ethoxylated fatty alcohols are used and, particularly no more than half that quantity.

The so-called gemini surfactants can be considered as further surfactants. Generally speaking, such compounds are understood to mean compounds that have two hydrophilic groups and two hydrophobic groups per molecule. As a rule, these groups are separated from one another by a “spacer.” The spacer is usually a hydrocarbon chain that is intended to be long enough such that the hydrophilic groups are a sufficient distance apart to be able to act independently of one another.

These types of surfactants are generally characterized by an unusually low critical micelle concentration and the ability to strongly reduce the surface tension of water. In exceptional cases, however, not only dimeric but also trimeric surfactants are meant by the term gemini surfactants.

Exemplary suitable gemini surfactants are sulfated hydroxy mixed ethers according to German Patent Application DE-A-43 21 022 or dimeralcohol-bis- and trimeralcohol-tris-sulfates and ether sulfates according to German Patent Application DE-A-195 03 061. Blocked end group dimeric and trimeric mixed ethers according to German Patent Application DE-A-195 13 391 are especially characterized by their bifunctionality and multifunctionality. Thus, the cited blocked end group surfactants possess good wetting properties and are therefore poorfoamers, such that they are particularly suited for use in automatic washing or cleaning processes.

However, gemini polyhydroxyfatty acid amides or polyhydroxyfatty acid amides, such as those described in International Patent Applications WO-A-95/19953, WO-A-95119954 and WO95-A-/19955 can also be used.

Among the compounds that serve as bleaching agents and liberate H₂O₂ in water, sodium perborate tetrahydrate, sodium perborate monohydrate and sodium percarbonate are of particular importance. Examples of further bleaching agents that may be used are peroxypyrophosphates, citrate perhydrates and H₂O₂-liberating peracidic salts or peracids, such as perbenzoates, peroxyphthalates, diperoxyazelaic acids, phthaloimino peracids or diperoxydodecanedioc acids. As already stated above, sodium percarbonate is used as the bleaching agent in a preferred embodiment.

Other detergent ingredients include graying inhibitors (soil carriers), foam inhibitors, bleach activators, optical brighteners, enzymes, textile softeners, colorants and scents and neutral salts such as sulfates and chlorides in the form of their sodium or potassium salts.

Bleach activators, which can be used are compounds which, under perhydrolysis conditions, produce aliphatic peroxycarboxylic acids having preferably 1 to 10 carbon atoms, in particular, 2 to 4 carbon atoms, and/or optionally substituted perbenzoic acid. Substances, which carry O-acyl and/or N-acyl groups of said number of carbon atoms and/or optionally substituted benzoyl groups, are suitable.

Preference is given to polyacylated alkylenediamines, in particular, tetraacetyl ethylenediamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoyl succinimide (NOSI), acylated phenol sulfonates, in particular, n-nonanoyl- or isononanoyloxybenzene sulfonate (n- or iso-NOBS), carboxylic acid anhydrides, in particular, phthalic anhydride, acylated polyhydric alcohols, in particular, triacetin, ethylene glycol diacetate and 2,5-diacetoxy-2,5-dihydrofuran and the enol esters known from German Patent Applications DE-A-196 16 693 and DE-A-196 16 767 and acetylated sorbitol and mannitol or their mixtures (SORMAN) described in European Patent Application EP-A-0 525 239, acylated sugar derivatives, in particular, pentaacetylglucose (PAG), pentaacetylfructose, tetraacetylxylose and octacetyllactose as well as acetylated, optionally N-alkylated glucamine and gluconolactone, and/or N-acylated lactams, for example, benzoylcaprolactam that are known from International Patent Applications WO-A-94/27970, WO-A-94/28102, WO-A-94/28103, WO-A-95/00626, WO-A-95/14759 and WO-A-95/17498. The hydrophilically substituted acylacetals, known from German Patent Application DE-A-196 16 769 and the acyllactams described in German Patent Application DE-A-196 16 770 as well as International Patent Application WO-A-95/14075 are also preferably used. The combinations of conventional bleach activators known from German Patent Application DE-A-44 43 177 can also be used. These types of bleach activators are comprised in the usual amounts, preferably in amounts of 1 wt. % to 10 wt. %, particularly 2 wt. % to 8 wt. %, based on the total detergent and/or cleanser.

When used in automatic washing processes, it can be advantageous to add conventional foam inhibitors to the detergents and/or cleansers. Suitable foam inhibitors include, for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanized silica and also paraffins, waxes, microcrystalline waxes and mixtures thereof with silanized silica or bis-stearyl ethylenediamide. Mixtures of various foam inhibitors, for example, mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material.

Especially in this case, mixtures of paraffins and bis stearylethylene diamides are preferred.

Suitable enzymes are, in particular, those from the classes of hydrolases, such as proteases, lipases or lipolytic enzymes, amylases, cellulases or mixtures thereof. Oxireductases are also suitable.

Enzymatic active materials obtained from bacterial sources or fungi such as bacillus subtilis, bacillus licheniformis, streptomyceus griseus and humicola insolens are particularly well suited. Proteases of the subtilisin type and particularly proteases that are obtained from bacillus lentus, are preferably used. Here, mixtures of enzymes are of particular interest, for example, proteases and amylases or proteases and lipases or lipolytic enzymes or proteases and cellulases or cellulases and lipases or lipolytic enzymes or proteases, amylases and lipases or lipolytic enzymes or proteases, lipases or lipolytic enzymes and cellulases, in particular, however, proteases and/or lipase-containing mixtures or mixtures with lipolytic enzymes. Examples of such lipolytic enzymes are the known cutinases. Peroxidases or oxidases have also proved to be suitable in certain cases. The suitable amylases particularly include alpha-amylases, iso-amylases, pullulanases and pectinases. Cellobiohydrolases, endoglucanases and beta-glucosidases, which are also known as cellobiases or mixtures thereof, are advantageously used as the cellulases. As the different cellulase types differ in their CMCase and avicelase activities, the required activities can be adjusted by controlled mixtures of the cellulases.

The enzymes can be adsorbed on carriers and/or embedded in cladding substances in order to protect them against premature decomposition. The content of the enzymes, enzyme mixtures or enzyme granules may be, for example, about 0.1 to 5% by weight and is preferably 0.1 to about 2% by weight.

In addition to phosphonates, the detergents and/or cleansers can comprise additional enzyme stabilizers. For example, 0.5 to 1 wt. % sodium formate can be added. It is also possible to add proteases that are stabilized with soluble calcium salts and a calcium content of preferably about 1.2 wt. %, based on the enzyme. Apart from calcium salts, magnesium salts also serve as stabilizers. However, the addition of boron compounds is particularly advantageous, for example, boric acid, oxides of boron, borax and other alkali metal borates such as the salts of orthoboric acid (H₃BO₃), metaboric acid (HBO₂) and pyroboric acid (tetraboric acid H₂B₄O₇).

Graying inhibitors have the function of maintaining the dirt that was removed from the fibers suspended in the washing liquor, thereby preventing the dirt to resettle. Water-soluble colloids of mostly organic nature are suitable for this, for example, the water-soluble salts of polymeric carboxylic acids, glue, gelatins, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the above-mentioned starch products, e.g., degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl celluloses, and mixed ethers such as methyl hydroxyethyl cellulose, methyl hydroxypropyl cellulose, methyl carboxymethyl cellulose and mixtures thereof, as well as polyvinyl pyrrolidone, which can be added, for example, in amounts of 0.1 to 5 wt. %, based on the detergent and/or cleanser.

The detergents and/or cleansers may contain derivatives of diaminostilbene disulfonic acid or alkali metal salts thereof as the optical brighteners. Suitable optical brighteners are, for example, salts of 4,4′-bis-(2-anilino-4-morpholino-1,3,5-triazinyl-6-amino)stilbene-2,2′-disulfonic acid or compounds of similar structure which contain a diethanolamino group, a methylamino group and anilino group or a 2-methoxyethylamino group instead of the morpholino group. Brighteners of the substituted diphenylstyryl type may also be present, for example, the alkali metal salts of 4,4′-bis-(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the mentioned brighteners may also be used.

The inventive detergents and/or cleansers can have any bulk density. The range of the possible bulk densities goes from low bulk densities below 600 g/l, for example, 300 g/l, through medium bulk densities of 600 to 750 g/l to high bulk densities of at least 750 g/l. In a preferred variant of the inventive detergent and/or cleanser having high bulk densities, the bulk density, however, is actually above 800 g/l, wherein bulk densities above 850 g/l can be particularly advantageous. The advantages of the soluble builder system are particularly important for these types of super compactants, as such compacted detergents and/or cleansers place particular requirements with regard to the good dispersibility of the ingredients.

Any process known from the prior art is suitable for manufacturing such detergents and/or cleansers.

The detergents and/or cleansers are manufactured by blending together the different particulate components that comprise the ingredients of the detergents and/or cleanser, and which together form at least 60 wt. % of the total detergent and/or cleanser.

However, it can be preferred that the acidifying component is mixed later with the detergent or cleanser, wherein the acidifying component is mixed either alone or in the form of compounds with other, preferably neutral reacting detergent or cleanser ingredients.

In this way the particulate components can be manufactured by spray drying, simple mixing or complex granulation processes, for example, fluidized bed granulation. Preferably, at least one surfactant-containing component is manufactured by fluidized bed granulation.

In addition, it may be particularly preferred when aqueous preparations of the alkali silicates and alkali carbonates are sprayed together in a drier with other ingredients of detergents and/or cleansers, such that a granulation occurs at the same time as the drying.

The dryer, in which the aqueous preparation is sprayed, can be any drying apparatus.

In a preferred process procedure, the drying is carried out as spray drying in a drying tower. For this, in the known method, the finely divided aqueous preparations encounter a dry gas flow. The spray drying can also be carried out with super-heated steam.

In another preferred variant, especially when it is intended to prepare high bulk density detergents and/or cleansers, the mixtures are subsequently subjected to a compaction step, wherein additional ingredients are blended with the detergents and/or cleansers only after the compaction step.

In a preferred embodiment of the invention, the compaction of the ingredients takes place in a pressure agglomeration process. The pressure agglomeration process to which the solid premix (dried detergent base) is subjected, can be carried out in various apparatuses. Different pressure agglomeration processes are differentiated according to the type of agglomerator used. The four most frequent and in the context of the present invention preferred pressure agglomeration processes are extrusion, roller press or compaction, punch press (pelletization) and tableting, so that in the context of the present invention, preferred pressure agglomeration operations are extrusion-, roller compaction-, pelletization- or tableting operations.

All of the cited preferred compaction processes have in common that the premix is densified under pressure and plasticized and the individual particles are pressed onto each other, and by reducing their porosity stick to each other. In all processes, (for tableting with limitations) the tooling can be heated to higher temperatures or cooled to remove the shear heating. A binding agent can be used in all processes as a compaction auxiliary.

In relation to this process, reference is expressly made to the contents of European Patents EP 0 486,592 B1 A1 and EP 0 931,137 B1.

A further subject of the invention is illustrated by the use of an inventive, essentially aluminosilicate-free, soluble builder system or the use of an inventive detergent and/or cleanser for inhibiting incrustations.

In a preferred embodiment of the invention, this use relates to inhibiting incrustations on at least partially hydrophobic or hydrophobically treated substrate surfaces, preferably textiles, particularly in the context of an automatic textile-washing process.

Hydrophobic substrate surfaces are understood to mean all such surfaces that are essentially hydrophobic, for example, many plastic surfaces, as well as many woven fabrics of synthetic fiber or woven fabrics that at least partially comprise synthetic fibers. Hydrophobic (water-repellent) is defined as the property of a molecule or a group of molecules to behave exophilically towards water, i.e. they have the tendency not to penetrate into water or the tendency to leave the aqueous phase. Water repellency is linked, for example, to aromatic groups or to hydrocarbon chains. Hydrophobic substrate surfaces are therefore essentially water repellent. These hydrophobic substrate surfaces are especially hydrophobically treated textiles or are plastic surfaces, e.g., consisting of rubber, polycarbonate or polypropylene or similar materials.

Hydrophobically treated textiles can be obtained, for example, by a water repellent impregnation of textiles. The hydrophobing agents employed coat the textile substrate, for example, with a thin layer that, e.g., possesses relatively many water repellent, hydrophobic groups. Such groups are, e.g., inter alia, long alkyl chains or siloxane groups. Exemplary suitable hydrophobing agents are silicones, alkyl alkoxysilanes. Similarly suitable hydrophobing agents for substrate surfaces are, e.g., paraffins, waxes and/or metal soaps, for example, with added aluminum- or zirconium salts, quaternary ammonium compounds with long chain alkyl groups, urea derivatives, fatty acid modified melamine resins, salts of chromium complexes, silicones, organo-tin compounds and glutardialdehyde. Hard or soft substrates or substrate surfaces, for example, woven textile fabric, can be hydrophobically treated with these or other hydrophobing agents. The hydrophobing treatment can also be made with tetrachloroethene-soluble additives, as are employed in “dry-cleaning.” Perfluorinated compounds can also be used for hydrophobing treatment.

Textiles, of course, may also be rendered hydrophobic by means of a plastic or rubber coating. Similarly, textiles may be hydrophobic per se, according to which family of fibers was predominantly used in their manufacture.

A further preferred embodiment is illustrated by the use in textile washing of an inventive, essentially aluminosilicate-free, soluble builder system or the use of an inventive detergent and/or cleanser to increase the whiteness and/or the color brilliance of the washing, especially of at least partially hydrophobic or hydrophobically treated textiles.

### EXAMPLE

Washing tests with various textiles or various types of fabrics were carried out, wherein two detergent compositions A and B were employed, B being an inventive detergent that included an inventive builder system. Composition A served as the control and differed from B essentially only in so far as it did not comprise any cationic surfactant.

| | |
|---|---|
| Detergent | Detergent |
| Composition A | Composition B |

| | |
|---|---|
| Ingredients: | (all data in wt. %) |

| | | |
|---|---|---|
| Alkylbenzene sulfonate (sodium salt) | 12 | 12 |
| Alkyldimethylhydroxyethylammonium | — | 1 |
| chloride | | |
| Carboxymethylcellulose | 1 | 1 |
| Enzyme | 1 | 1 |
| Nonionic Surfactant | 3 | 3 |
| (1-Hydroxyethylidene)bisphosphonate | 1 | 1 |
| Citric acid | 1 | 1 |
| Sodium carbonate | 25 | 25 |
| Sodium percarbonate | 13 | 13 |
| Sodium silicate | 5 | 5 |
| Sodium sulfate | 27 | 26 |
| Polyacrylate | 3 | 3 |
| Foam inhibitor | 2 | 2 |
| N,N,N,N-Tetraacetylethylendiamine | 3 | 3 |
| Water | 3 | 3 |
| Total | 100 | 100 |

Sodium silicate: Amorphous sodium silicate with Na₂O:SiO₂=2.4
Polyacrylate: Norasol LMW 45N®; polyacrylic acid, sodium salt; M=4,500 g/mol; commercial product of NorsoHaas company
   1. Conditions for the Washing Tests

Wash temperature: 60° C., Washing machine type: Miele Novotronic W135, Wash program: Boil/colored wash. a) WFK (standard cotton fabric), b) H-FT-B (cotton toweling), c) Noblesse ( hydrophobically treated cotton) and d) viscose were used as test fabrics.

Results:

It was determined that the incrustations (see TABLE 1) were significantly reduced, principally on the hydrophobically treated textiles, by using the inventive detergent B that comprised the inventive, soluble builder system; similarly, principally with these textiles, the whiteness was improved (see TABLE 2).

The incrustations were each determined by ashing after the 25^{th} wash. The quantity of ash in wt. % for each type of fabric is presented in TABLE 1, below. When the detergent comprised an inventive, soluble builder system as in the inventive case, composition B, then the washed textiles of all four types of fabrics consistently showed advantages with respect to incrustation in comparison with the results obtained with the comparative detergent of composition A, as demonstrated by the lower ash contents.

The reduced ash was particularly significant for the hydrophobically treated cotton (Noblesse) and the viscose. An ash reduction of more than 40% was observed for both types of fabric.

TABLE 1
Ashing:

| | Quantitative results: Ash (wt. %) | | | |
|---|---|---|---|---|
| | WFK | H-FT-B | Noblesse | Viscose |
| Detergent composition A | 3.65 | 4.44 | 7.73 | 2.51 |
| Detergent composition B | 2.92 | 3.7 | 4.48 | 1.42 |

The tests therefore demonstrated that the tendency to precipitation on textiles, particularly on hydrophobically treated textiles was significantly reduced when using detergents that comprise the inventive, soluble builder system.

Similarly, the whiteness was advantageously improved for the textiles when an inventive detergent (composition B) and its associated builder system were used. This is documented in TABLE 2 by the consistently higher values for the tristimulus value Y, determined after the 25^{th} wash.

TABLE 2
Graying

| | Quantitative results: Tristimulus Value Y | | | |
|---|---|---|---|---|
| | (International Electrotechnical Commission) | | | |
| | WFK | H-FT-B | Noblesse | Viscose |
| Detergent composition A | 80.5 | 77.5 | 84 | 85.7 |
| Detergent composition B | 82.2 | 83.3 | 85.7 | 87.5 |

1. A soluble builder system composition that is free or essentially free of aluminosilicate, said composition comprising:
a) alkali carbonate,
b) polymeric polycarboxylate, and/or copolymeric polycarboxylate; and
c) cationic surfactant.

2. The composition according to claim 1, wherein said composition comprises alkali carbonate in amounts of up to 90 wt. % based on the total builder system composition.

3. The composition according to claim 1, wherein said composition comprises polymeric polycarboxylate and/or copolymeric polycarboxylate(s) in amounts up to 20 wt. % based on the total builder system composition.

4. The composition according to claim 1, wherein said composition comprises cationic surfactants in amounts up to 5 wt. % based on the total builder system composition.

5. The composition according to claim 1, wherein said composition comprises at least one additional complexing agent.

6. The composition according to claim 1, wherein said composition comprises an alkali silicate.

7. The composition according to claim 6, wherein the alkali silicate is an amorphous sodium silicate with a modulus Na₂O : SiO₂ in the range of 1:2 to1:2.8.

8. The composition according to claim 1, wherein said composition comprises an acidifying component.

9. A soluble builder system composition that is free or essentially free of aluminosilicate, said composition comprising:
a) alkali carbonate;
b) polymeric polycarboxylate, and/or copolymeric polycarboxylate; and
c) a quaternary ammonium compound.

10. The composition according to claim 9, wherein the quaternary ammonium compound is in accordance with Formula (I),
R¹(R²)(R³)(R⁴)N⁺X⁻, (I)
in which R¹, R² and R³ independently of one another are selected from C₁-C₄ alkyl, C₁-C₄ hydroxyalkyl, benzyl and —(C₂H₄O)ₓH, with x equal to 2 through 5, and wherein R⁴ is a C₈-C₂₂ alkyl, and wherein X⁻ is an anion, preferably a halide, methosulfate, methophosphate or phosphate ion as well as mixtures thereof.

11. The composition according to claim 9, wherein the quaternary ammonium compound is in accordance with Formula (II),
R⁵R⁶ₙR⁷₃₋NN⁺X⁻ (II)
wherein R⁵ is a C₆-C₂₄ alkyl or alkenyl, wherein each R⁶ independently of one another is a —(CₙH₂ₙO)ₓR⁸ group, with n equal to 1 through 4 and with x equal to 1 through 14, and wherein R⁸ is a methyl, ethyl or preferably a hydrogen, and wherein each R⁷ independently of one another is a C₁-C₁₂ alkyl or alkenyl group, with m equal to 1 through 3, and wherein X⁻ is an anion, preferably a halide, methosulfate, methophosphate or phosphate ion as well as mixtures thereof.

12. The composition according to claim 11, wherein R⁶ is a CH₂CH₂OH, each R⁷ independently of one another is a C₁-C₄ alkyl, with m equal to 1 or 2, and wherein R⁵ is a linear C₆-C₁₄ alkyl group.

13. The composition according to claim 9, wherein the cationic surfactant is a C₈-C₁₆-alkyl Di(hydroxyethyl)-methyl ammonium compound.

14. A detergent or cleanser comprising a composition according to claim 1.

15. The detergent or cleanser according to claim 14, wherein the composition comprises the soluble builder system in amounts of up to 50 wt. %, based on the total detergent or cleanser.

16. The detergent or cleanser according to claim 14, wherein the composition is totally free of aluminosilicate.

17. A method of inhibiting formation of incrustations on a surface, said method comprising the step of treating the surface with a soluble builder system composition that is free or essentially free of aluminosilicate, said composition comprising:
a) alkali carbonate;
b) polymeric polycarboxylate, and/or copolymeric polycarboxylate; and
c) cationic surfactant.

18. The method according to claim 17, wherein the surface is at least partially hydrophobic or a hydrophobically treated substrate surface.

19. The method for increasing the whiteness and/or the color brilliance of textiles comprising the step of applying to the textiles the composition of claim 1.

20. The method for increasing the whiteness and/or the color brilliance of at least partially hydrophobic or hydrophobically treated textiles, comprising the step of treating textiles with the composition of claim 1.
